(19) United States
(12) Patent Application Publication
(10) Pub. No.: US 2024/0256719 A1
(43) Pub. Date: Aug. 1, 2024

(54) DEEP LEARNING BASED METHOD TO GENERATE A DENTAL PROSTHESIS

(71) Applicant: The University of Hong Kong, Hong Kong (CN)

(72) Inventors: Wuyuan Zhao, Hong Kong (CN); Hao Ding, Hong Kong (CN); James Kit Hon Tsoi, Hong Kong (CN); Jiamin Wu, Hong Kong (CN)

(73) Assignee: The University of Hong Kong, Hong Kong (CN)

(21) Appl. No.: 18/429,195

(22) Filed: Jan. 31, 2024

Related U.S. Application Data
(60) Provisional application No. 63/442,688, filed on Feb. 1, 2023.

(51) Int. Cl. G06F 30/10; A61C 13/34; G06T 5/20; G06T 5/60; G06T 5/70; G06T 5/73

(52) U.S. Cl. CPC G06F 30/10; A61C 13/34; G06T 5/20; G06T 5/60; G06T 5/70; G06T 5/73; G06T 2207/20028; G06T 2207/20084; G06T 2207/20192; G06T 2207/30036

(57) ABSTRACT

A computer-implemented geometric processing method generates the design for a model of a dental prosthesis beginning with obtaining a blended prosthesis dataset for dental prostheses including natural tooth data and prosthesis tooth data designed by a technician. This dataset is preprocessed by generating a depth map with preprocessing so that the data is more suitable for deep learning (DL) so as to ensure generation of a smooth surface. An artificial intelligence neural network generation model with tooth feature loss is trained on the preprocessed dataset and is used to form a model of the prosthesis. Then the dental information associated with the dental model of dentition is used to generate a 3D dental prosthesis surface with a post-processing method to meet the requirement of the dental prosthesis. Finally, the rest of the dental prosthesis is completed to meet full function.

### CROSS-REFERENCE TO RELATED PATENT APPLICATIONS

This application claims the benefit of priority under 35 U.S.C. Section 119(e) of U.S. Application No. 63/442,688, filed Feb. 1, 2023, which is incorporated herein by reference in its entirety.

### FIELD OF THE INVENTION

The present invention relates to the creation of a dental prosthesis and, more particularly, to the creation of a dental prosthesis using deep learning based methods to solve dental computer aided design problems.

### BACKGROUND OF THE INVENTION

Tooth defects are one of the most common oral diseases and require restorative treatment. These defects in tooth hard tissue structures are caused by caries, trauma or acid erosion and are a common and frequently occurring disease in the mouth. The prevalence rate of such kinds of tooth defect can be as high as 24%˜53% (ca. 2.8 billion people with dental caries, 0.27 billion people with edentulism and severe tooth loss in 2017, affecting globally 7.5 billion people).

A dental crown is usually needed when a tooth is damaged or has a large cavity that cannot be treated with direct fillings. It is also used after a root canal treatment to protect the remaining tooth structure.

Digital dentistry has been advocated as a way to provide a better patient and dentist experience due to faster diagnosis and manufacturing processes for prostheses. As such, computer-aided design (CAD) and computer-aided manufacturing (CAM) have been significantly involved in digital dentistry. However, these CAD and CAM are still operated by humans.

In order to build an automatic dental CAD system, human expertise is needed to integrate models of prostheses into software. One approach is to build a comprehensive set of rules that would include all the nuances known to experienced dental professionals and formulate them in a way that machines can understand. This is a very tedious task, and obviously feasible only when this set of rules can be provided. The other approach is to build a system capable of learning from a large number of examples without explicit formulation of the rules, which is an artificial intelligence (AI) approach called data-driven deep learning (DL).

In recent research, deep learning (DL) methods [3, 11, 18] have been used to reconstruct missing tooth surfaces. As an image-based method, commonly the 3D intraoral scan is represented as a 2D depth image obtained from a given plane, which involves a down sampling process. There are some papers and patents disclosing the use of deep learning based methods to solve dental CAD problems. For example, U.S. Pat. No. 11,291,532 discloses a computer-implemented method of recognizing dental information that includes training a deep neural network to map a plurality of training dental models to a probability vector. The method includes receiving and recognizing dental information, e.g. the contour of a crown, by applying the trained deep neural network to determine a category, as opposed to generating a prosthesis. This patent provides limited information on the training dataset, i.e., that a convolutional neural network (CNN) is used and it is preprocessed by generating a depth map, but without any other methods to remove noise and discontinuous steps. The groove, pit, fossa and ridge are important features for a tooth. A mathematical definition to tell the network that these areas are more important than others is needed, but this patent states nothing about this lack of information.

US Application Publication 2021-0267730 discloses a computer-implemented method for generating dental restoration associated with a dental model of dentition. The method includes using a trained deep neural network to generate a first 3D dental prosthesis model based on the received patient scan data. The trained deep neural network comprises a generative adversarial network (GAN). Like U.S. Pat. No. 11,291,532 this publication does not disclose a way to handle the importance of groove, pit, fossa and ridge features. Further, its training data set comprises a dentition scan set with preparation site data and a dental prosthesis data set. The dental prosthesis data set comprises scanned prosthesis data associated with each preparation site in the dentition scan data set. In order to generate a good prosthesis a method must generate the outer part or surface of the prosthesis with sufficient reconstruction accuracy under limited resolution and without noise points. The publication does not provide this.

Despite the potential of this new technology, there are several challenges that need to be addressed for its practical application. First, for pixel/voxel-based data, the accuracy and roughness are limited by resolution, i.e. which means that low reconstruction accuracy is achievable under limited resolution. However, higher resolution usually results in increased memory consumption, which may render the program inoperable. Therefore, the first challenge is to identify a 3D reconstruction and mesh smoothing method that can meet the accuracy [14, 15], roughness and mechanical requirements of clinical applications while minimizing memory consumption. Second, in a clinical application of dental restorations, the accurate reproduction of anatomical shape is crucial for achieving successful outcomes. Therefore, it is important to develop a generative model that can maximize the likelihood of generating restorations with precise and accurate anatomical shapes. This will ensure that the designed prostheses closely resemble the natural dentition. Third, there are two distinct datasets available: natural teeth and technician-designed prosthesis. Previous studies have been based on separate datasets. [3, 11, 18] However, is essential to clarify how these two datasets are utilized as training sets. Further, it is crucial to establish a systematic approach that incorporates both datasets effectively, ensuring that the generative model learns from the natural teeth while also benefiting from the expertise of technicians in designing prostheses. This combined approach will enhance the overall accuracy and quality of the generated dental restorations.

The following are some prior literature references related to this patent:

### 1. 3D Reconstruction

Regardless of the method chosen to generate the inner surface and connecting surface of a dental crown, the primary challenge lies in registering the generated outer surface at the corresponding position in 3D space with sufficient accuracy for clinical applications. Traditional methods for converting 3D point data to surface data include the marching cubes (MC) method [21], the radial basis function (RBF) method [1], and the Delaunay triangulation (DT) method [2]. The MC method constructs a faceted iso-surface by processing the data set in a sequential, cube-by-cube manner. However, it has drawbacks such as high computational costs in the traversal phase and degeneracies and ambiguities in the extracted iso-surface. In the depth map, one approach is to transform the depth map into a voxel representation and then use the MC method. However, this can lead to incompletely reconstructed surfaces due to the loss of 3D information in the depth map. On the other hand, the RBF method achieves noise robustness by utilizing normal information from the point cloud. Nonetheless, this is not available in depth map, making it inappropriate for processing depth map data. Delaunay triangulations (DT) are commonly used to create topological structures from unorganized or unstructured points. The DT method is known for its simple and intuitive nature. However, it can be sensitive to noise in the input data, which can affect the quality of the resulting triangulation. One approach that has been mentioned in a paper is the region growing DT method. However, it is important to note that the effectiveness of this method for reconstruction purposes has not been thoroughly evaluated in the particular paper [18].

### 2. Mesh Smoothing

Mesh smoothing encompasses two aspects: denoising and fairing. Surface fairing is an aspect of mesh smoothing where the goal is to compute shapes that are as smooth as possible. Obtaining a noise-free and sufficiently smooth mesh directly from a 2D depth map generative model for reconstructing the 3D mesh can be challenging. Both mesh fairing and mesh denoising techniques are necessary to meet the clinical requirements.

There are 3 different types of mesh smoothing: 1. Filter based methods: These include Laplacian smoothing, Bilateral Mesh Denoising [4], Bilateral Normal Filtering [23], Guided Bilateral Filter [22], Fast and Effective Feature-Preserving Mesh Denoising [17], Non-iterative, feature preserving mesh smoothing [13], Manifold Harmonics and so on. 2. Optimization-based methods: L0 smoothing [8]. 3. Data-driven methods [20]. However, it should be noted that these general mesh smoothing methods may not be suitable for objects with specific anatomical morphology, such as teeth, which are in constant contact with the soft and hard tissues of the oral cavity and lack sharp corner structures.

### 3. A Model for Generating Dental Prosthetics Based on Deep Learning

Hwang and Tian utilized 2D-GAN models to generate dental crowns. These models learned from dental technicians' designs using 2D depth maps converted from 3D tooth models. [11, 18] Ding introduced a 3D-Deep Convolutional GAN (DCGAN) network for generating dental crowns [3]. This approach directly uses 3D data. Residual Network (ResNet) was designed to address the problem of training very deep neural networks. [7] Traditional tooth generating deep networks (Pix2Pix) sometimes suffer from the vanishing gradient problem, where the gradients used to update the network's weights become very small as they propagate backward through numerous layers. Generative Adversarial Network with Gradient Penalty (GAN-GP) is an extension of the standard Generative Adversarial Network (GAN) [5] framework that incorporates a gradient penalty term to improve the stability and training dynamics of the GAN. [6]

### 4. Quality Assessment for a Digital Dental Prosthesis

Commonly the quality assessment involves evaluation of generated image from the perspective of 2D computer vision Evaluation Parameters include mean Root Mean-Square Error (RMSE), Mean Intersection-over-Union (IOU), Peak Signal Noise Ratio (PSNR), Structural Similarity Index Measure (SSIM), and Feature Similarity Index Measure (FSIM) [11, 18]. In particular, evaluation of a generated image from the perspective of dentistry Evaluation Parameters include penetration (penetration rate, average maximum penetration, average penetration areas), and contact point analysis (average number of clusters, average spread deviation) [11]. Recently, for digitalized dental data, evaluation of generated 3D mesh from the perspective of computer graphic Evaluation Parameters includes RMSE for mesh [3, 11, 18]. Further, evaluation of generated 3D mesh from the morphology and mechanical performance of dentistry parameters includes cusp angle, occlusal contact measurement and Finite Element Analysis (FEA) [3].

Thus, more work needs to be done before prosthesis can be manufactured and applied in a clinical setting with accuracy and ease. In particular, there are numerous problems that need to be solved in order to have an effective way of using CAD with deep learning to generate a prosthesis. There is currently no generation method that ensures that the generated prosthesis meets the requirements of accuracy, surface roughness, anatomical morphology, and mechanical properties simultaneously.

### SUMMARY OF THE INVENTION

The present invention is directed to the improved production of dental prosthesis through the use computer-aided design using data-driven deep learning (DL). In particular, the invention combines modified DL reconstruction to achieve accurate and mechanically suitable results, e.g., at a 256×256 depth map resolution for three units of teeth, and also introduces a loss for tooth anatomical features and smooth surfaces in artificial intelligence generation algorithms such as GAN, Denoising Diffusion Probabilistic Model (DDPM) or Toothfeature Artificial Intelligence Generated method. Further, the resolution can be increased for more units of teeth or deep implicit representation (DIR) can be used to obtain any resolution. By using opposite teeth constraints improved model results are achieved compared to constraints that do not.

The invention is an improvement in three aspects of dataset and data processing including (1) a generation algorithm, (2) a post-processing part and (3) solving other the problems encountered in a deep learning based generation method for designing dental prosthesis. From the dataset and data preprocessing part the method of the invention uses a blended prosthesis dataset for training of the dataset and data preprocessing part of the invention. The blended prosthesis database contains three types of tooth data: 1. natural tooth data, 2. tooth data designed by a technician and 3. tooth data designed by a technician with clinical adjustment of the occlusion or “modified digital design.” The dental prosthesis design in the database not only has the correct anatomical shape, but also has the correct clinical occlusal relationship. It integrates the natural tooth, technical design tooth and clinically adjusted tooth. A digital image/geometric preprocessing method is adopted to ensure generation of a smooth surface in a DL approach. The digital image/geometric pre-processing method is a filter with edge-preservation and a noise-reducing smoothing function such as a Bilateral filter for the image, a Bilateral Mesh Denoising function and/or a Bilateral Normal Filter for the mesh.

In the course of generating an algorithm as part of the system and method, in addition to using a fixed resolution (such as 256*256) as noted above, a DL model with deep implicit representation (DIR) can be used to generate the dental prosthesis with macro shape and micro pits and fissures. For the loss function of the generating model (i.e., the importance of the groove, pit, fossa and ridge features), a special loss for the dental prosthesis with tooth features is adapted. The key idea of DIR is to learn a function which, given a coarse shape encoded as a vector, and the x-y-z/x-y coordinates of a query point, decide whether the point is inside or outside of the shape. The learned implicit function can be evaluated at query 3D/2D points at arbitrary resolutions, and the mesh/image can be extracted applying the classical marching cubes or other algorithms. This output representation enables shape recovery at arbitrary resolutions, is continuous and can handle different topologies.

With regard to the post-processing part, a digital geometry processing method is used after generation of the prosthesis is adopted to ensure that the 3D shape can meet the requirements of accuracy and a smooth surface for manufacturing and clinical use. There are two conditions for applying the digital geometry processing method. The first case or condition is when the resolution of 3D space is sufficient. Then diffusion-based feature-preserving techniques, such as Laplacian Smooth, are used. The second case or condition is when the resolution of 3D space is insufficient. Then modified normal methods can be used to smooth the normal and can also be used to avoid mutually perpendicular normal vectors. Sharp edges do not exist in dental prostheses. Then this modified normal is used to update the vertices. A method of registration fitting is further used to determine the relative position of the teeth and CAD software is used to complete the rest of the prosthesis. Adjacent teeth can used for registration of a single tooth. Also, other registration algorithms are feasible.

It is impossible to build an expert system that include all the nuances known to the experienced dental professionals and to formulate them in a way that machines can understand. While deep learning based methods simply rely on hardware and software, so the large-scale application of this method and the creation of the product is feasible. Further, the cost of the software is fixed once product development is completed. The price of hardware or cloud service used for computing the invention has decreased over time.

There is a conflict between personalized tooth shape and quantitative occlusal distribution, and the present invention uses a deep learning model to achieve a balanced result compared to prior art deep learning methods. In particular, no current deep learning based methods can generate a prosthesis that meets the requirement for manufacturing and clinical use.

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIG. 1 is a flow chart of a method according to the present invention;

FIG. 2A shows tooth feature images using the Laplacian of Gaussian (LoG) operator with different σ, where σ=0.7, 0.8, 0.9 and the LoG value <0; and FIG. 2B shows negatives of the same images;

FIG. 3 shows the architecture of the ToothGAN model;

FIG. 4 shows the workflow of the ToothGAN model;

FIG. 5A is a mold of natural teeth, FIG. 5B is a mold designed by a human technician and FIG. 5C is a modified digital design according to the present invention;

FIGS. 6A and 6B are images from a 2D/3D file before and after digital image/geometric preprocessing, respectively;

FIGS. 7A and 7B are molds from a 2D/3D file before and after digital image/geometric pre-processing, respectively;

FIG. 8 is a representation of a DL model with deep implicit representation using a multi-layer perception (MLP) portion of a feed forward neural network;

FIG. 9A is an original image of three teeth, FIG. 9B is an image of key tooth features on each of three teeth, FIG. 9C is an image of the row of teeth with the center one missing, FIG. 9D is an image of a prosthesis filing the gap between the teeth in FIG. 6C and FIG. 9E is an image of the gap left by the missing tooth;

FIG. 10A and FIG. 10B are 3D files before and after digital geometric post-processing, respectively; FIG. 10C shows the position of the generated prosthesis before registration, FIG. 10D shows the registration of the generated restoration to the position of the original missing dentition, and FIG. 10E shows the position of the generated prosthesis after registration;

FIG. 11 is an image of a 3D file after digital geometric post-processing showing registration of two adjacent teeth that meet the registration accuracy requirement;

FIG. 12 is a mold after registration, using a dental CAD to complete the rest of a prosthesis;

FIG. 13 shows images of crowns generated by ToothGAN and other methods based on a 467 natural tooth dataset plus a 347 technician-designed dataset compared to ground truth;

FIG. 14 shows a visualization of comparisons between ToothGAN and Technician Design;

FIG. 15A shows a visualization of the contact area of a ToothGAN design and FIG. 15B shows a visualization of the contact area of a technician design;

FIG. 16A the prediction Πq(p) for a point p based on a point on the surface at g being the projection of p to the plane tangent to the surface at q, FIG. 16B shows that noisy normals can lead to poor predictors and FIG. 16C shows that application of a mollified normal alleviates the problem of noisy normals;

FIG. 17 is the LoG image of non-smooth mesh surfaces and inaccurate dental anatomical features;

FIG. 18 shows typical technician designs teeth (middle of 3 teeth) and natural teeth; and

FIGS. 19A-D show shapes created by different generating and smoothing methods where FIG. 19A shows the result of Pix2Pix2-BNF, FIG. 19B shows the result of Pix2Pix2-NI FIG. 19C shows the result of ResUnet-GANGP-BNF and FIG. 19D shows result of ResUnet-GANGP-NI.

### DETAILED DESCRIPTION OF THE INVENTION

The present invention is a computer-implemented method of deep learning used to generate a dental prosthesis. The method includes (a) building a dataset for the dental prosthesis; (b) preprocessing the data so it is more suitable for deep learning; (c) building a special network to train the neural network, (d) identifying the dental information associated with a dental model of dentition, (e) generating a dental prosthesis with a post-processing method to meet the requirement of the dental prosthesis, and (f) completing the entire dental prosthesis to meet full function.

An exemplary embodiment of the invention uses a dataset consisting of 400 sets of natural teeth from healthy young adults. This dataset includes a total of 100 full-mouth models, with tooth positions taken from the top, bottom, left, and right sides. Additionally, for testing purposes, 40 sets of natural teeth are selected, which include 10 full mouth models with tooth positions taken from the same areas as the training dataset. In addition to the natural teeth dataset, the embodiment also incorporated 314 sets of technician-designed teeth from clinical cases where second premolars (tooth No. 6 in the ISO notation system) were missing. To ensure consistency, each individual tooth (excluding the gum portion) was segmented and isolated, while retaining the adjacent teeth and opposing teeth for the missing tooth site. Another 25 natural teeth were used as the test set, 10 clinical cases were used to compare the results generated by the technicians and the network. The original STL file was converted into a 256 resolution depth map for training and testing.

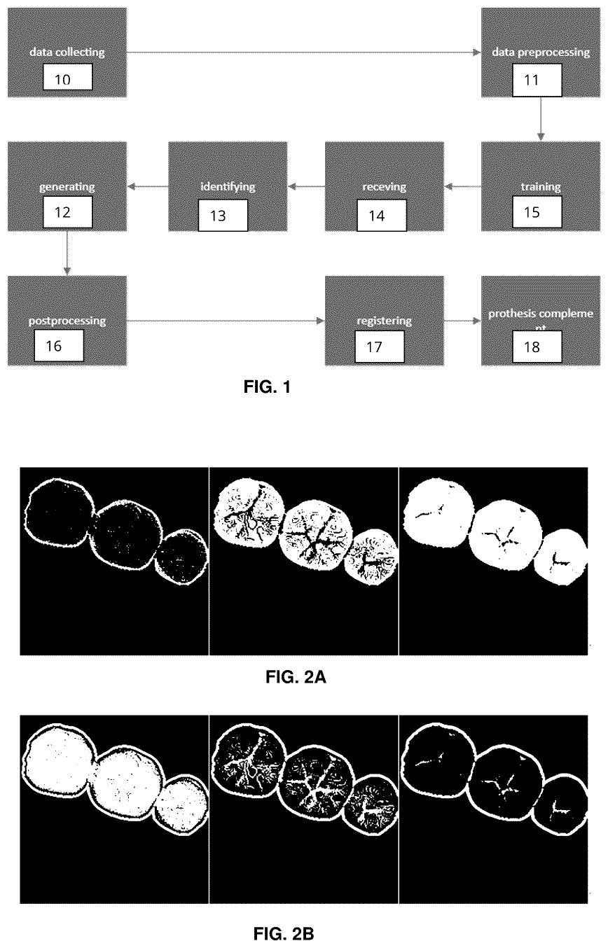

FIG. 1 is a flow chart of a method according to the present invention. Data is collected at step 10 from a large number of patients and their proper prosthesis. At step 11 this data is preprocessed into a form more suitable for deep learning. Deep learning models are very powerful in some tasks. To achieve good results, those models require a certain amount of data to train on and steps 10 and 11 serve this purpose. The processed data is applied to a neural network in step 12 so as to train the network. In particular, the network is a system that is capable of learning from a large number of examples without explicit formulation of rules, which is an artificial intelligence (AI) approach called data-driven deep learning (DL). After a sufficient amount of training, the system can produce a design for a prosthesis that is compatible with a patient's tooth defect.

The design is received from the training system at step 13. In step 14 the dental information associated with a dental model of dentition is identified. Based on this identification a dental prosthesis model is generated at step 15 to meet the requirement of a dental prosthesis. This prosthesis is subjected to a post-processing method at step 16. Next at step 17 the design is registered and finally at step 18 the entire dental prosthesis is completed to meet its full function. In particular, in order to get the inner surface and combine it with the generated outer surface (or the occlusal surface), the following steps are followed: (1). Offset the upper part of the tooth preparation by a given distance to simulate the use of an adhesive layer. (2). Design the connector mesh surface by using the boundary curves of the generated outer surface (or the occlusal surface) and the adhesive layer, as the reference lines. There are ready-made algorithms that can perform this or CAD software can be used directly to complete them.

Delaunay triangulations were used to build topological structures from unorganized (or unstructured) points. The input to this method is a list of points specified in 3D, even though the triangulation is 2D. Thus, the triangulation is constructed in the x-y plane, and the z coordinate is ignored (although carried through to the output). The vtkDelaunay2D Class was directly used to implement the reconstructions.

Adjusted Non-Iterative, Feature Preserving Mesh Filtering was used because each pixel in the depth map has the same area on the projection plane, the area is not used as the coefficient in the method. The estimate p′ for a point on surface S is delete:

$${p}^{′} = \frac{1}{k ( p )} {\sum }_{q ∈ S} {\prod }_{q} {p}_{f ( {c}_{q} - p ) g ( {\prod }_{q} ( p ) - p )}$$

Maar and Hildreth propose the Laplacian of Gaussian (LoG) operator [16]. The LoG operator contains two parts: the Gaussian smoothing filter function and the Laplacian function. The anatomical tooth features like groove, fossa, ridge are the extreme points in the image. So, this operator is directly used with different σ to extract the features of the tooth. The calculation formula for LoG is as follows:

$$LOG = \frac{{x}^{2} + {y}^{2} - 2 {σ}^{2}}{{σ}^{4}} {e}^{- ( {x}^{2} + {y}^{2} + ) / 2 {σ}^{2}}$$

From the tooth pictures in FIG. 2 it is clear that when σ=0.8 and LoG value >0, the tooth feature image is obtained. Therefore, these parameters are kept constant in the network architecture. The size and standard deviation of the LoG template N follow a Gaussian distribution principle known as “3σ Principle.” This principle states that the values outside plus or minus 3σ from the mean are very small. Therefore, the LoG template size should be selected as an odd number greater than 6σ as per this principle.

By combining ResNet and GAN-GP to form ToothGAN, a better result is achieved than the original Pix2Pix model. However, the invention is not limited to the use of GAN and this algorithm can apply to other generation algorithms, such as generating diffusion models—DDPM (Denoising Diffusion Probabilistic Model) or other Toothfeature Artificial Intelligence Generated methods.

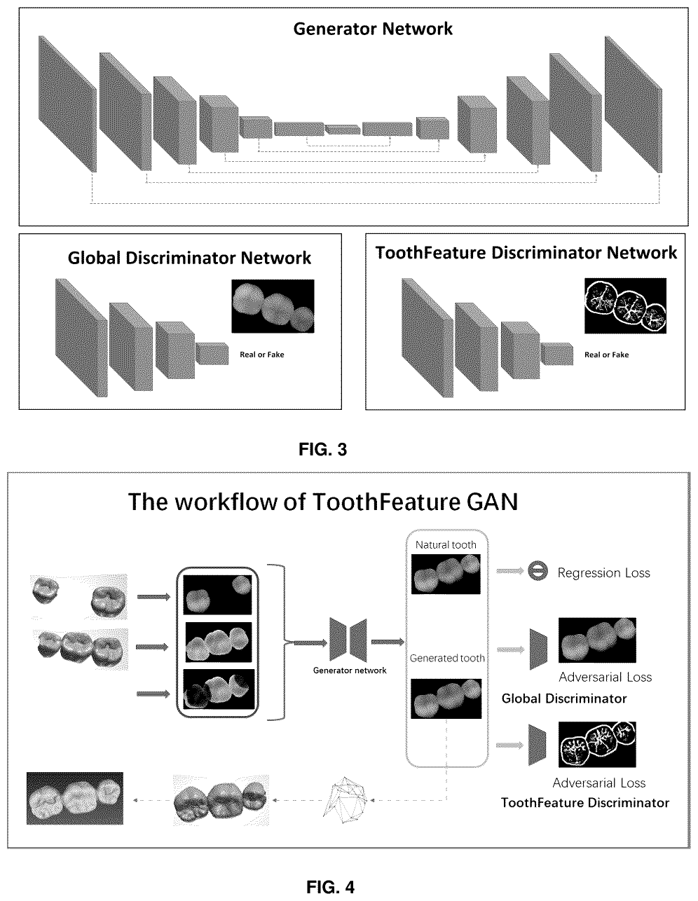

The structure of these two discriminators is the same (see FIG. 3), but the input images are different:

$${L}_{{D}_{Global}} = {𝔼}_{\tilde{x} \sim {P}_{g}} [ D ( \tilde{x} ) ] - 𝔼 \text{?} [ D ( x ) ] + λ 𝔼 \text{?} [ {( {‖ {∇}_{\tilde{x}} D ( \hat{x} ) ‖}_{2} - 1 )}^{2} ] \\ {L}_{{D}_{ToothFeature}} = {𝔼}_{\tilde{x} \sim {P}_{g}} [ D ( \tilde{x} ) ] - 𝔼 \text{?} [ D ( x ) ] + λ {𝔼}_{\hat{x} \sim {P}_{\tilde{x}}} [ {( {‖ {∇}_{\hat{x}} D ( \hat{x} ) ‖}_{2} - 1 )}^{2} ]$$

$$\text{?} \text{indicates text missing or illegible when filed}$$

A comprehensive generation loss with 2 discriminators and L1 loss:

$${L}_{G} = - 𝔼 \text{?} [ {D}_{Global} ( \tilde{x} ) ] - {λ}_{1} 𝔼 \text{?} [ {D}_{ToothFeature} ( \tilde{x} ) ] + {λ}_{2} {L}_{{L}_{1}} ]$$

$$\text{?} \text{indicates text missing or illegible when filed}$$

An image workflow of the ToothGAN is shown in FIG. 4.

For the training procedure the Adam optimizer was used with a learning rate of 0.0002. The momentum parameters were set to β1=0.5 and β2=0.999. All networks, except for toothGAN, were trained from scratch, while toothGAN utilized pretrained parameters. Weights for all layers were initialized using the default initialization methods in PyTorch. Each experiment underwent training for 200 epochs, with a batch size of 8.

A quality assessment was determined based on RMSE and SSIM for generated 2D images. RMSE is used for measuring the average difference between a predicted crown picture and the ground truth picture. SSIM is used for measuring the similarity between two images: the predicted crown picture and the ground truth picture. Note that the ground truth uses only natural teeth, and measurement of the errors is performed in the all 3 crown regions to accurately assess the per-pixel quality in RMSE and SSIM.

The 3D accuracy for the 3D mesh was determined by 3D deviation analysis to detect the distance between the generated STL file and the original scan data in the outer surface area. The root mean square (RMS) was calculated.

In addition to conventional image and mesh quantification evaluation methods, the degree of anatomical matching between the generated crown and adjacent teeth were also subjectively evaluated by four evaluators who had more than three years of clinical experience. The evaluators were blinded to each group and were asked to complete a questionnaire that assessed the degree of shape matching satisfaction on a scale ranging from 0 to 5.

A digital approach was adopted to measure the occlusal contact point number and area using MeshLab software. The STL file of the tooth to be measured and its opposing dentition were imported into the software. A distance heat map was obtained at the opposite dentition using the functions “Distance from Reference Mesh” and “Colorize by Vertex Quality.”. A 0-1 mm range of occlusal distance was selected. Given that the thickness of bite registration for dental use ranges from −50 to 100 μm, the distance below 100 μm was included as the contact area. The number of contact points and areas can be obtained by the software accordingly (“Select by Vertex Quality” function followed by “Compute Area” function).

Due to significant differences in the morphology of two objects, digital roughness is a global testing method that cannot provide good feedback on roughness values. Therefore, in the end, a value is introduced to describe the local roughness. If the in the area of the occlusal surface, the number of continuous irregular(unsmoothing) triangles >10, we mark this mesh with a sharp mesh conner.

Statistical analysis was performed using SPSS software (version 27.0; IBM, Armonk, NY, USA). The statistical significance of the accuracy, digital roughness, 3D discrepancy, and occlusal contact among the different groups was studied using one-way analysis of variance (ANOVA) and Tukey's HSD post hoc multiple comparisons. The level of significance was set at α=0.05.

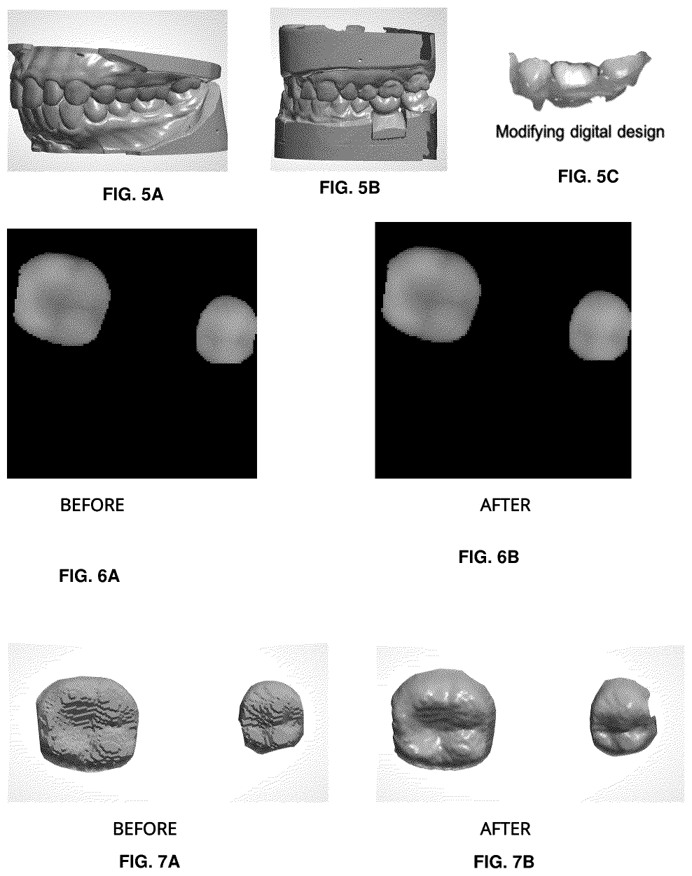

The effect of the invention can be seen in FIG. 5A-5C. Current designs are all based on datasets designed by dental technicians. However, the prosthesis designed by technicians often need to be adjusted by dentist. So, these designs are not the most appropriate for the patient. The present invention uses a blended prosthesis dataset with natural teeth, technically designed teeth and clinically adjusted teeth. In particular, FIG. 5A illustrates a mold of natural teeth, while FIG. 5B is a mold designed by a human technician. FIG. 5C is a modified digital design according to the present invention. The effects of the preprocessing step 11 are shown in FIGS. 6A and 6B, which are images from a 2D/3D file before and after digital image/geometric preprocessing, respectively. FIGS. 7A and 7B are models from a 2D/3D file before and after digital image/geometric pre-processing, respectively. Note that the effect is to smooth the design.

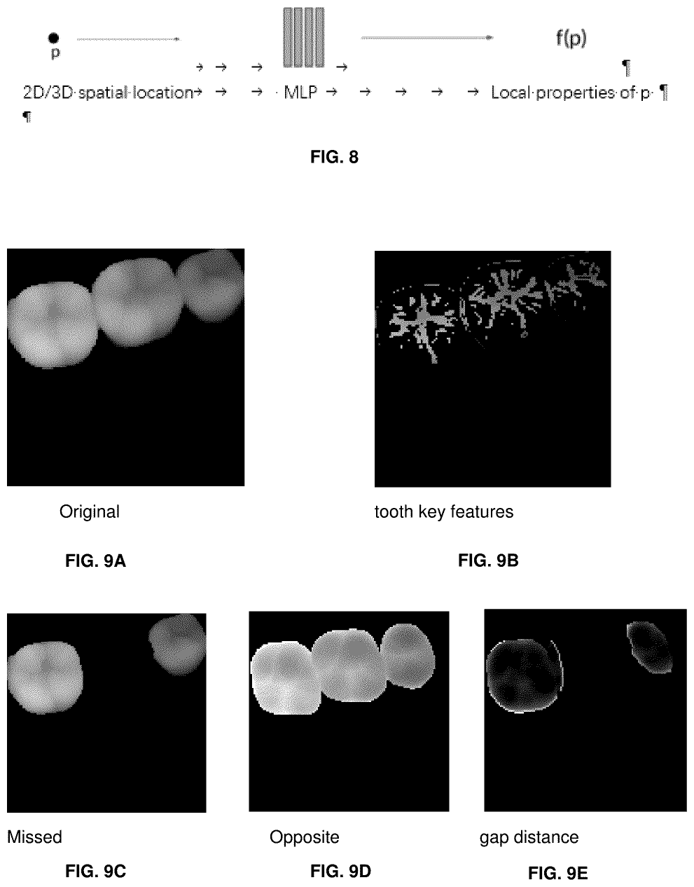

FIG. 8 is a representation of a DL model with deep implicit representation using a multi-layer perception (MLP) portion of a feed forward neural network. MLP is a supplement to a feed forward neural network. It consists of three types of layers—the input layer, output layer and hidden layer. The input layer receives the input signal to be processed. Instead of representing an image/3D object with a fixed resolution, the present invention proposes a continuous representation for images. By modeling an image as a function defined in a continuous domain, the image in arbitrary resolution can be restored and generated if needed, as shown in FIG. 8.

The groove, pit, fossa and ridge are important features for teeth. A mathematical definition of these features is needed to inform the network that these areas are more important than others. A loss function measures how good a neural network model is in performing a certain task, which in most cases is regression or classification. Efforts are made to minimize the value of the loss function during a backpropagation step in order to make the neural network perform better. For the loss item of a generating model of the present invention, a special loss for dental prosthesis with occlusal and shape are adapted. The special loss with tooth feature value for the dental prosthesis is used in conjunction with Regression loss function: Mean Absolute Error (MAE) loss (L1 loss), Mean Square Error (MSE) loss (L2 loss), smooth L1 loss, Huber loss, perceptual loss; or with the loss function in GAN including Jensen-Shannon (JS) Divergence loss and Wasserstein loss. In the present invention a tooth key features is used to solve this problem. FIG. 9A is an original image of three teeth and FIG. 9B is an image of key tooth features on each of three teeth.

The shape and features are important for a prosthesis. Occlusion is also a fundamental requirement in dental restorations, and occlusal adjustment is clinically essential in daily dental treatment. Dental occlusion is defined as the static or dynamic inter-arch relation and corresponds to all possible contacts established between the opposing teeth. The present invention uses a histogram of gap distances to get the right occlusal distribution. FIG. 9C is an mage of the row of teeth with the center one missing. FIG. 9D is an image of a prosthesis filling the gap. FIG. 9E is an image of the gap distance left by the missing tooth.

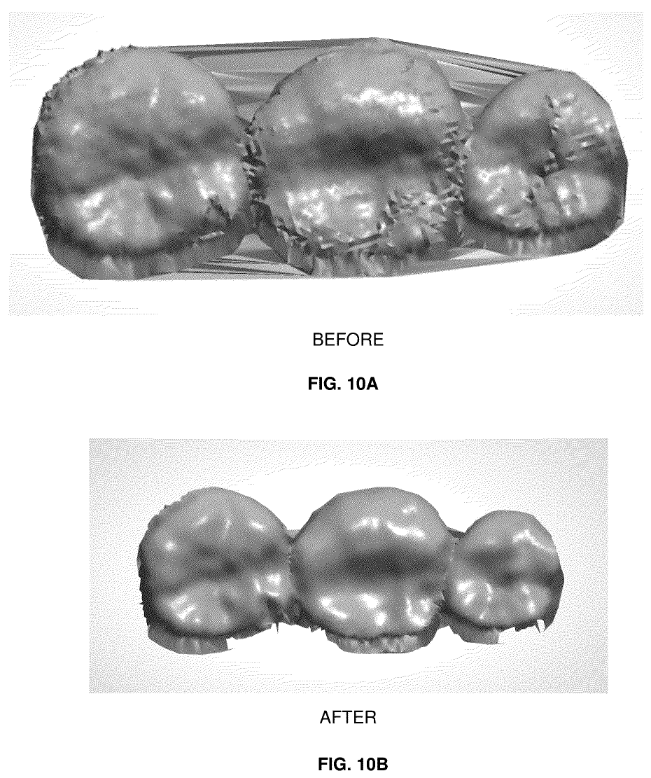

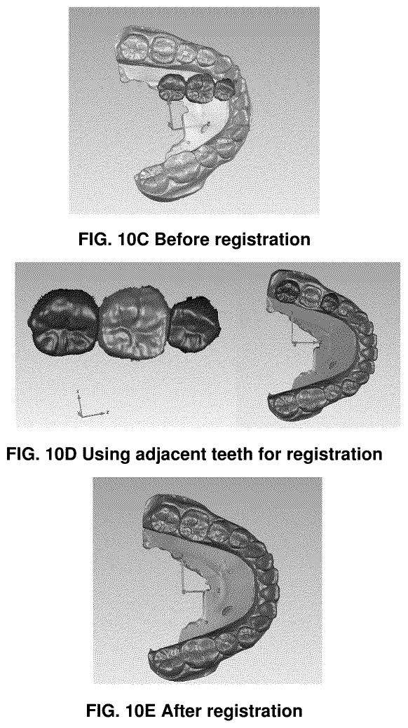

After the deep learning based generation of step 12, the 2D image or 3D file is obtained. The next problem is how a 2D-image/3D file can be processed to meet the 3D-STL requirement for clinical and manufacturing, where STL is a file format native to the stereolithography CAD software created by 3D Systems. FIG. 10A and FIG. 10B are 3D files before and after digital geometric post-processing, respectively. As this process is applied it smooths the design. When generating a prosthesis, the jaw teeth are used to constrain (i.e. the jaw teeth are constrained) to generate a suitable occlusion relationship, and after generating the prosthesis, adjacent teeth are used to constrain alignment to register the restoration to a suitable spatial position. As shown in FIG. 10C, before registration, the generated restoration is not accurately located in the original dentition space; As shown in FIG. 10D, the generated restoration is registered to the position of the original missing dentition with two adjacent teeth as reference surfaces; In the generated dental prosthesis model, adjacent tooth constraints are used to achieve alignment, as shown in FIG. 10E. After registration, the generated restoration is accurately positioned in the original dentition space.

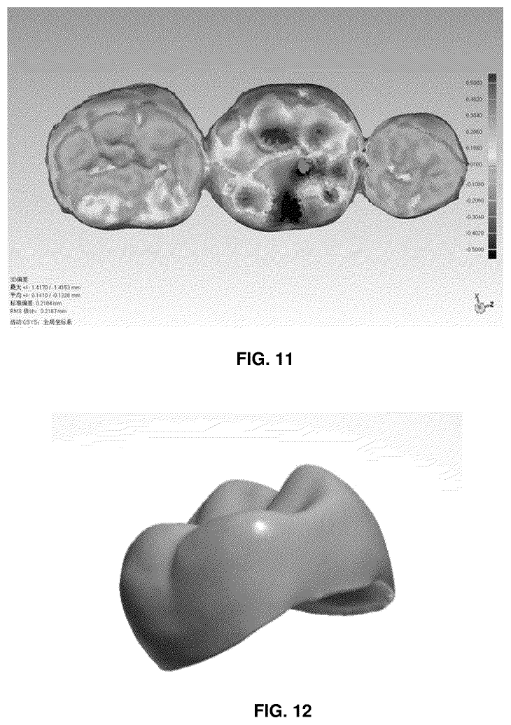

FIG. 11 is an image from a 3D file after digital geometric post-processing showing registration of two adjacent teeth meeting the registration accuracy requirement. FIG. 12 is a model after registration, using a dental CAD to complete the rest of a prosthesis.

If a point cloud reconstruction method is used, there are two problems. For pix or vox based data, the accuracy is limited by the resolution and because the generated point is the size of the probability, some randomly generated points are difficult to avoid. If the method just generates the outer surface or part of the prosthesis, geometric processing is needed that has sufficient reconstruction accuracy under limited resolution and can remove noise points. A geometry method is adapted to solve this problem. See for example Delaunay triangulations and Adjusted Non-Iterative, Feature Preserving Mesh Filtering.

The result of ToothGAN combined with 3D reconstruction using a 467 natural teeth dataset can be considered. The result of 2DRMSE, 2D SSIM, 3D RMS, visual assessment and sharp mesh corner rate are considered. From the analysis of the results in Table 1 obtained from Groups ResUnet-GANGP (WOO467) and ResUnetGANGP Opposite Tooth for condition (WO467), the introduction of antagonist data has led to statistically significant improvements in various metrics, including: 2D RMSE 272 (WOO467: 0.0038±0.0012, WO467: 0.0028±0.0010), 2D SSIM (WOO467: 0.9815±0.0102, WO467: 0.9886±0.0083), 3D RMS (WOO467: 0.482±0.065 275 mm, WO467: 0.340±0.0950 mm), Visual assessment scores (WOO467: 1.6±1, WO467: 2.2±0.7), sharp mesh corner rate (WOO467: 0/25, WO467: 21/25).

However, the incorporation of jaw data has also resulted in a statistically significant increase in the sharp mesh corner rate. On the other hand, ToothGAN 467 has demonstrated enhancements across all metrics, including 2DRMSE, 2D SSIM, 3D RMS, visual assessment scores, and the sharp mesh corner rate. 2D RMSE (WOO467: 0.0038±0.0012, WO467: 0.0028±0.0010, ToothGAN467: 0.0027±0.0009), 2D SSIM (WOO467: 0.9815±0.0102, WO467: 0.9886±0.0083, ToothGAN467: 0.9895±0.0063), 3D RMS (WOO467: 0.482±0.065 mm, WO467: 0.340±0.0950 mm, ToothGAN467: 0.316±0.076 mm).

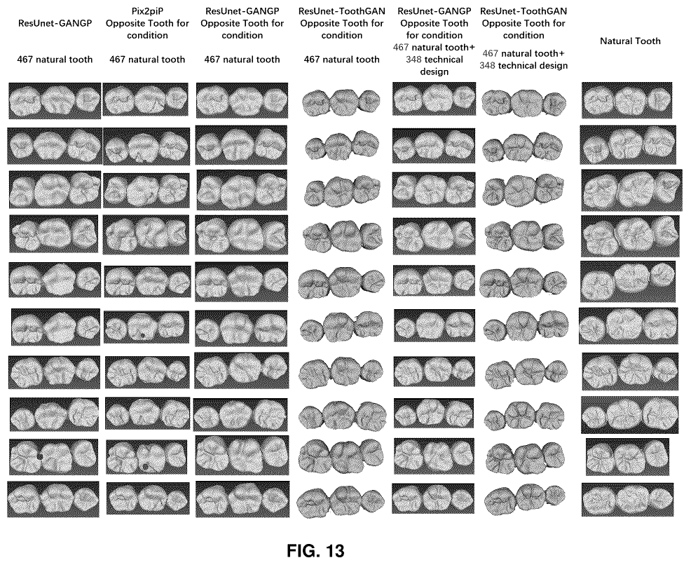

Visual assessment scores in FIG. 13 and Table 1 (WOO467: 1.6±1, WO467: 2.2±0.7, ToothGAN467: 3.4±1), sharp mesh corner rate (WOO467: 0/25, WO467: 21/25, ToothGAN467: 0/25). The comprehensive improvement across these diverse metrics signifies the robustness and potential of ToothGAN in generating high-quality tooth models. From the visualization results of 3D mesh reconstruction, compared with ground truth, the general anatomical morphology of the generated dental crowns is similar. Moreover, compared to other methods, the ToothGAN method can retain more anatomical features while removing noise and making the surface smoother.

TABLE 1
Result of ToothGAN combined with 3D reconstruction using 467 natural tooth dataset

| Group | RSME ↓ | SSIM ↑ | 3DRMS ↓ | VA ↑ | SMCR ↓ |
|---|---|---|---|---|---|
| Reunet-GANGP | 0.0038(0.0012) | 0.9815(0.0102) | 0.482(0.065)^{g} | 1.6(1.0)ⁱ | 0/25 |
| Pix2Pix-Op | 0.0029(0.0012)^{b} | 0.9874(0.0083)^{e} | 0.324(0.082)ⁿ | 1.0(0.0)^{J} | 25/25 |
| ReUnet-GANGP-Op | 0.0028(0.0010)^{b} | 0.9886(0.0068)^{e} | 0.340(0.095)ⁿ | 2.2(0.7)^{k} | 21/25 |
| ResUnet-ToothGAN-Op | 0.0027(0.0009)^{b} | 0.9895(0.0063)^{e} | 0.316(0.076)ⁿ | 3.4(1.0)^{l} | 0/25 |

*Different superscript letters indicate significant differences (p < 0.05)

The result of ToothGAN combined with 3D reconstruction using a 467 natural tooth dataset plus 347 technician designs as training dataset was investigated. As one aspect, the result of 2DRMSE, 2D SSIM, 3D RMS, visual assessment and sharp mesh conner rate were studied.

After introducing an additional dataset of 347 technician-designed dental crowns as shown in Table 2, there were no statistically significant improvements observed for ToothGAN compared to ResUnet-GANGP in terms of the 2D RMSE (WO815: 0.0028±0.0010, ToothGAN815: 0.0027±0.0009), 2D SSIM (WO815: 0.9886±0.0068, ToothGAN815: 0.9895±0.0063), and 3D RMS (WO815: 0.340±0.095, ToothGAN815: 0.316±0.076) metrics.

TABLE 2
Result of ToothGAN combined with 3D reconstruction using
467 natural tooth + 347 technician design dataset

| Group | RSME ↓ | SSIM ↑ | 3DRMS ↓ | SMCR ↓ |
|---|---|---|---|---|
| ResUnet-GANGP-Op | 0.0028(0.0010)^{a} | 0.9886(0.0068)^{c} | 0.3061(0.0902)^{e} | 12/25 |
| ResUnet-ToothGAN-Op | 0.0027(0.0009)^{a} | 0.9895(0.0063)^{c} | 0.2937(0.0802)^{e} | 0/25 |

*Different superscript letters indicate significant differences (p < 0.05)

Specifically, even though the statistical significance was not established, the reduction in mean values for these metrics within ToothGAN indicates a potential trend towards enhanced accuracy and similarity, suggesting that ToothGAN's results might be more consistently aligned with the reference data, although the effect was not strong enough to reach statistical significance.

In regard to the assessment of sharp mesh corner rates, when juxtaposed with the dataset containing information from 467 natural teeth, the inclusion of the supplementary 347 dental crown designs led to modest improvements in the performance of ResUnet-GANGP (WO467:21/25, WO815:12/25). Furthermore, ToothGAN maintained its result of 0 sharp mesh corners out of 25, reaffirming its ability to consistently produce tooth models with smooth and natural geometries.

As part of determining the results of ToothGAN, human expert visual assessment (VA) was also considered. An additional intriguing outcome pertains to the human expert visual assessment results in Table 3. The introduction of dental crown data designed by technicians, which often feature deeper grooves compared to adjacent teeth, has led to the generation of dental crowns with deeper grooves following the incorporation of the supplementary dataset of 347 technician-designed dental crown designs. These deeper grooves may not necessarily align with the preferences of all clinicians, leading to a divergence in opinions during the subjective evaluation process.

TABLE 3
The result of human expert visual assessment with different dataset

| | VA ↑ | VA ↑ | VA ↑ |
|---|---|---|---|
| Group | (4 dentists) | (2 dentists, G1) | (2 dentists, G2) |
| GANGP | 3.4(0.9)^{a} | 3.5(0.8)^{e} | 3.3(0.9)ⁱ |
| (467 + 348) | | | |
| ToothGAN | 3.6(1.2)^{b} | 3.0(1.1)^{f} | 4.1(1.2)^{j} |
| (467 + 348) | | | |
| GANGP | 2.2(0.7)^{b} | 2.6(0.8)^{f} | 1.8(0.4)^{k} |
| (467) | | | |
| ToothGAN | 3.4(1.0)^{b} | 4.1(0.8)^{e} | 2.7(0.7)ⁱ |
| (467) | | | |

*Different superscript letters indicate significant (p < 0.05)

Among the four participating clinicians who conducted the visual assessments, a notable divergence emerged in their preferences for groove depth. Two clinicians opted to assign higher scores to dental crowns with deeper grooves, while the remaining two clinicians favored dental crowns with shallower grooves, matching the groove depth of adjacent teeth. From the visualization results of 3D mesh reconstruction, when the technician-design dataset is added, the pits and fissures that form the crowns become deeper. And these deeper pits and fissures may not be available in natural teeth.

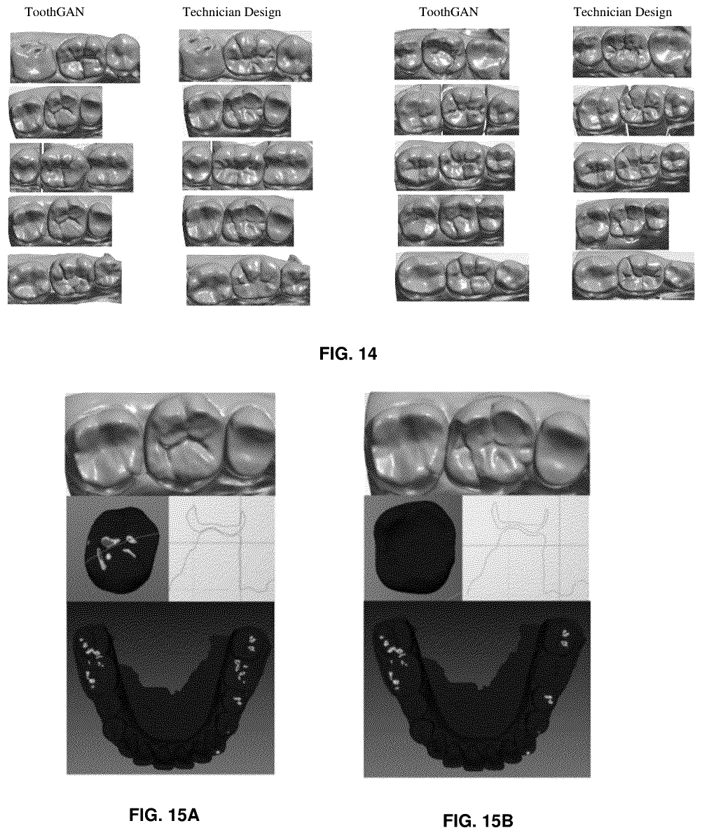

Also reviewed were the results of ToothGAN combined with 3D reconstruction using 467 natural tooth dataset+347 technician-designed restorations as a training dataset on an actual clinical case. In this review the result of human expert visual assessment was considered. It can be observed that, in terms of subjective ratings in Table 4 and FIG. 14, there is no statistically significant difference between the dental restorations generated by ToothGAN (6.70±1.10) and those designed by technicians (7.40±1.02).

TABLE 4
Human expert visual assessment results
of ToothGAN and Technician Design

| Group | VA ↑ |
|---|---|
| ToothGAN(n = 10) | 6.70(1.10)^{a} |
| Technician Design (n = 10) | 7.40(1.02)^{a} |

*Different superscript letters indicate significant (p < 0.05)

From the results regarding occlusal contact area in Table 5, there is a difference between the dental restorations generated by ToothGAN (2.398±3.148) and those designed by technicians (0.279±0.627). Technician-designed restorations tend to have either no occlusal contact points or very few contact points, while ToothGAN-generated restorations exhibit a preference for occlusal points that align more closely with those of adjacent teeth. See FIG. 15A for a visualization of the contact area of a ToothGAN-generated design and FIG. 15B for a visualization of the contact area of a technician design.

TABLE 5
Contact area of ToothGAN and Technician Design

| | Contact Area |
|---|---|
| Group | (mm²) |
| ToothGAN (n = 10) | 2.398(3.148)^{a} |
| Technician Design(n = 10) | 0.279(0.627)^{a} |

*Different superscript letters indicate significant (p < 0.05)

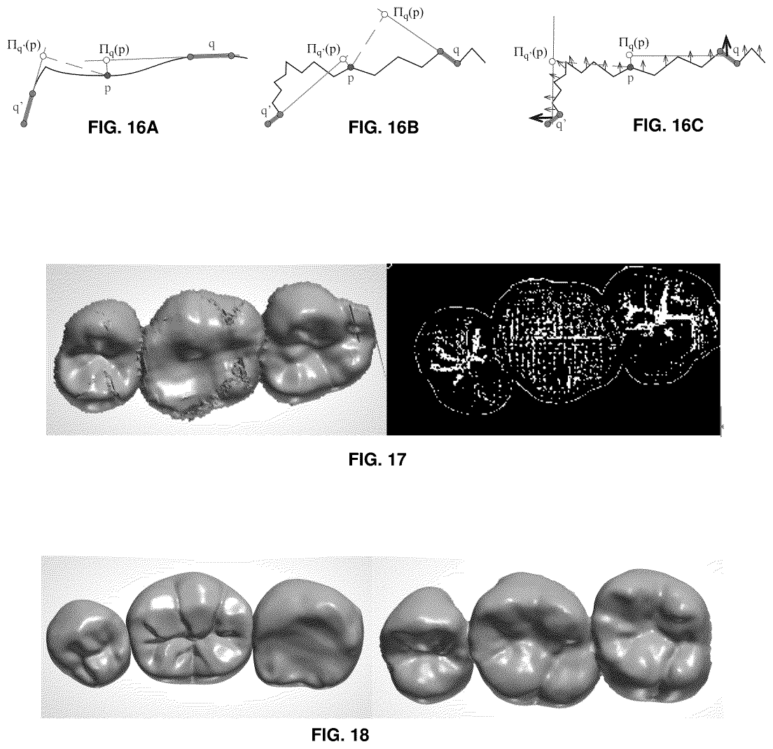

A good result can be achieved by the adoption of noniterative, feature-preserving mesh smoothing. The normal vector on the face is not changed directly, while a mollification method needs to be modified, not the 0-order (location) to solve the normal problem. The positions of the vertices are not altered at all; only the first-order properties (the normal). See FIGS. 16A-C, where FIG. 16A shows the prediction Πq(p) for a point p based on a point on the surface at g being the projection of p to the plane tangent to the surface at q. Points across a sharp feature result in predictions that are farther away, and therefore given less influence. FIG. 16B shows that noisy normals can lead to poor predictors. FIG. 16C shows that mollified normals alleviate this problem. Note that corners are preserved because points are not displaced by the mollification: only the normals are smoothed.

In previous studies, the material mechanical properties of the three-dimensional reconstruction of a dental prostheses were not considered. However, with the present invention the geometric processing method was verified to assure that it can avoid sharp edges and corners and avoid stress concentration while removing noise and maintaining accuracy so that it can meet material mechanical properties.

The results of 3D reconstruction with tooth feature loss in ToothGAN were reviewed. In a prior study by Tian[18], their network architecture consisted of one generator, two DuNet discriminators, and one GroNet parser. The DuNet was trained to distinguish real occlusal surface images from those generated by the generator network. GroNet, pretrained by a Pix2Pix model, remained fixed to enhance the harmony of generated grooves with object pixels. The key distinctions are as follows for the Loss Function part:
1) Tooth features encompass grooves, high points of the tooth's appearance, pits, and marginal ridges. Using a proposed Laplacian of Gaussian (LoG) operator, all these features in the tooth feature map can be identified.
2) An automated tooth feature extractor was employed, thereby eliminating the need for manual labeling (GroNet), ensuring comprehensive feature coverage.
3) Importantly, the LoG method involved extracting the second derivative of original values. Irregularities in three dimensional mesh surfaces may yield non-zero second derivatives, contributing to significant loss values (see FIG. 17). This ensures that generated dental restorations posses both accurate anatomical features and appropriate surface smoothness and continuity of anatomical features.
4) The model of the present invention is more compact with fewer parameters, making it easier to train. In contrast to Tian's work, which includes one generator, two DuNet discriminators, and one GroNet parser, the model of the present invention includes one generator and two DuNet discriminators. Additionally, this model can apply tooth features to various loss functions, including L1, L2, and MSE.

The introduced tooth feature maps can extend to new generative models, such as generative diffusion models [9]. Furthermore, this invention marks the first to assess whether 3D reconstructed dental prostheses generated through GANs can satisfy requirements for tooth features, accuracy, roughness and mechanical properties simultaneously.

Previous studies haven't explored the impact of different datasets (natural teeth and technician-designed teeth) on generative performance. For natural teeth, consistency is high, with better results seen as the training dataset size increases However, with technician-designed teeth, manually added features can complicate things. As the training dataset grows, some metrics improve, like resembling real teeth and having the correct cusp, groove, and fissure count. But some metrics decline, including deeper grooves and altered occlusal contact points. This happens due to the inclusion of technician-designed features that may not match natural teeth characteristics. (see FIG. 18)

This divergence in training data results suggests a practical approach for dental restoration design using generative AI:
a. The larger the amount of individual data information during training, the better (such as including opposing teeth)
b. Begin with initial training on a diverse data by training the AI model on a broad dataset that includes natural and technician-designed teeth. This phase helps the model learn various dental characteristics.
c. Fine-tune for specific preferences by, after initial training, fine-tuning the model based on individual dentist preferences or disease categories. Dentists can provide guidance to customize AI-generated dental restorations.
d. Establish an Iterative Feedback Loop. In particular, create an ongoing feedback loop where clinicians continuously assess and refine AI-generated restorations, ensuring the model evolves and aligns better with clinical needs.

In a further embodiment of the present invention, a 3D reconstruction method combined with 2D GAN is used to generate a dental crown that meets the mechanical properties (accuracy, roughness, resistance to fracture) required for clinical use. In this embodiment 400 sets of natural teeth from teenagers were used for training. There are a total of 100 full mouth models, with 6 tooth positions taken from the top, bottom, left, and right. Ten (10) sets of natural teeth were used for testing with a Pix2Pix-GP and ResUnet-GANGP model with depth map data.

An Optimized Delaunay triangulator method was used for 3D reconstruction from the depth map. Non-Iterative, Feature Preserving Mesh Filtering (NI) and Bilateral Normal Filtering for Mesh Denoising (BNF) and no smoothing (NS) were employed for the control group. A quick digital roughness assessment method based on fast mesh perceptual distance (FMPD) was used. 3D deviation analysis was performed to detect the distance between the generated STL and original scan data on the outer surface area. A color-difference map was generated, and the root mean square (RMS) was calculated.

Statistical analysis was performed using SPSS software (version 27.0; IBM, Armonk, NY, USA). The statistical significance of the accuracy, digital roughness, FEA result, cusp angle, 3D discrepancy, and occlusal contact among the different groups was studied using one-way analysis of variance (ANOVA) and Tukey's HSD post hoc multiple comparisons. The level of significance was set at α=0.05.

The Depth Map Directly Converted from Mesh (n=10) as follows:
NS group: 3D RMS=0.046±0.003 mm, 3D Digital roughness=1.12±0.12
BNF group: 3D RMS=0.034±0.003 mm, 3D Digital roughness=0.52±0.09
NI group: 3D RMS=0.035±0.003 mm, 3D Digital roughness=0.41±0.12

The Depth Map from Pix2Pix and ResUnet-GANGP Result on Whole Teeth (n=10) was as follows:

### Whole Tooth for Pix2Pix Group:

BNF group: 3D RMS=0.3026±0.0467 mm, 3D Digital roughness=2.092±0.302
NI group: 3D RMS=0.3019±0.0593 mm, 3D Digital roughness=1.853±0.286

### Whole Tooth for ResUnet-GANGP Group:

BNF group: 3D RMS=0.3063±0.0644 mm, 3D Digital roughness=1.611±0.379
NI group: 3D RMS=0.3166±0.0762 mm, 3D Digital roughness=1.041±0.261

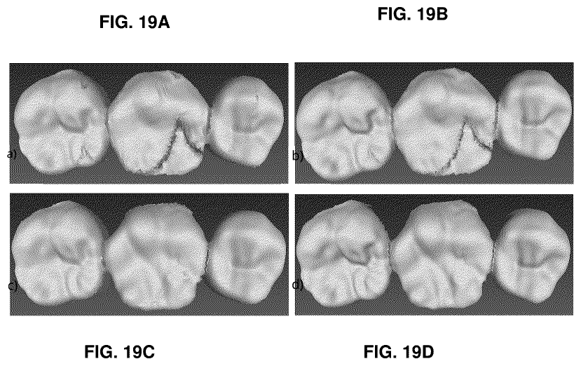

The ResNet was designed to address the problem of training very deep neural networks. Traditional tooth generating deep networks (Pix2Pix) sometimes suffer from the vanishing gradient problem, where the gradients used to update the network's weights become very small as they propagate backward through numerous layers. GAN-GP is an extension of the standard Generative Adversarial Network (GAN) framework that incorporates a gradient penalty term to improve the stability and training dynamics of the GAN. By combining ResNet and GAN-GP, a better result than the original Pix2Pix model is achieved. See FIG. 19 which shows the different generating and smoothing methods. FIG. 19A shows the result of Pix2Pix2-BNF, FIG. 19B shows the result of Pix2Pix2-NI, FIG. 19C shows result of the ResUnet-GANGP-BNF and FIG. 19D shows result of the ResUnet-GANGP-NI.

The surface roughness of the grid is also a very important indicator. The RMS value of the mesh does not represent the roughness value. The major purpose of fast mesh perceptual distance (FMPD) is to assess the mesh visual quality, and it consist of 3 parts: 1) Local roughness, LR 2) Roughness modulation 3) Global roughness GR computation. Since the Roughness modulation is to account for the visual masking effect and the so-called psychometric saturation effect, it is not necessary in this work, so it was ignored. Also, the maximum value of 1 was removed to show the differences more clearly between different mesh surfaces in “Global roughness computation”.

$${LR}_{i} = \vert {GC}_{l} + \frac{{\sum }_{j ∈ {N}^{( v )}} {D}_{i , j} * {GC}_{j}}{{D}_{i , i}} \vert \\ GR = \frac{{\sum }_{i} {LR}_{i} * {S}_{i}}{{\sum }_{i} {S}_{i}} \\ {FMPD}_{{M}_{r} {M}_{d}} = \vert GR - {GR}^{′} \vert$$

Non-Iterative, Feature-Preserving Mesh Smoothing can achieve a good result because the normal vector on the face is not changed directly, while this smoothing adapts a mollification method. It does not alter the positions of the vertices at all. They only need to mollify the first-order properties (the normal), not the 0-order (location) to solve the normal problem. The usefulness of this method is also verified by the experimental results (accuracy, roughness). This can be seen from FIG. 16A-C.

As a result, this embodiment provides a quick (<5 s) digital roughness assessment method that can evaluate the relative roughness of the whole prosthesis. Further, it provides a 3D reconstruction through the Delaunay triangulator method with an NI smoothing method to achieve a good result for both accuracy and roughness in the direct data or generating from deep learning model. By combining ResNet and GAN-GP with a natural tooth dataset, a better result is achieved than with the original Pix2Pix model.

In summary, the present invention involves a digital geometric processing method that combines modified DT reconstruction to achieve accurate and mechanically suitable results at a 256×256 depth map resolution. A loss for tooth anatomical features is introduced to smooth surfaces in ToothGAN, which outperforms prior algorithms when applied to natural tooth datasets. By using opposite teeth constraints improved model results are achieved when compared to constraints that do not use this method, but it will cause uneven surfaces at the junction of the upper and lower jaw without further processing. Mixing natural tooth scans with technician-designed data helps the model learn common features like having the correct cusp, groove, but leads to some metrics decline, including deeper grooves and altered occlusal contact points. This happens due to the inclusion of technician-designed features that may not match natural teeth characteristics In clinical dental restoration cases, ToothGAN-designed crowns were on par with technician-designed crowns in subjective appearance evaluations. ToothGAN also showed better uniformity in occlusal contacts relative to adjacent teeth.

### REFERENCES

The cited references in this application are incorporated herein by reference in their entirety and are as follows:
[1] Jonathan C Carr, Richard K Beatson, Jon B Cherrie, Tim J Mitchell, W Richard Fright, Bruce C McCallum, and Tim R Evans. Reconstruction and representation of 3d objects with radial basis functions. In Proceedings of the 28th annual conference on Computer graphics and interactive techniques, pages 67-76, 2001. 1
[2] Frederic Cazals and Joachim Giesen. Delaunay triangulation based surface reconstruction. In Effective computational geometry for curves and surfaces, pages 231-276. Springer, 2006. 2
[3] Hao Ding, Zhiming Cui, Ebrahim Maghami, Yanning Chen, Jukka Pekka Matinlinna, Edmond Ho Nang Pow, Alex Siu Lun Fok, Michael Francis Burrow, Wenping Wang, and James Kit Hon Tsoi. Morphology and mechanical performance of dental crown designed by 3d-dcgan. Dental Mate-rials, 39(3):320-332, 2023. 1, 2
[4] Shachar Fleishman, Iddo Drori, and Daniel Cohen-Or. Bi-lateral mesh denoising. In ACM SIGGRAPH 2003 Papers, pages 950-953. 2003. 2
[5] Ian Goodfellow, Jean Pouget-Abadie, Mehdi Mirza, Bing Xu, David Warde-Farley, Sherjil Ozair, Aaron Courville, and Yoshua Bengio. Generative adversarial networks. Communications of the ACM, 63(11): 139-144, 2020. 2
[6] Ishaan Gulrajani, Faruk Ahmed, Martin Arjovsky, Vincent Dumoulin, and Aaron C Courville. Improved training of wasserstein gans. Advances in neural information processing systems, 30, 2017. 2
[7] Kaiming He, Xiangyu Zhang, Shaoqing Ren, and Jian Sun. Deep residual learning for image recognition. In Proceedings of the IEEE conference on computer vision and pattern recognition, pages 770-778, 2016. 2
[8] Lei He and Scott Schaefer. Mesh denoising via I 0 minimization. ACM Transactions on Graphics (TOG), 32(4):1-8, 2013. 2
[9] Jonathan Ho, Ajay Jain, and Pieter Abbeel. Denoising diffusion probabilistic models. Advances in neural information processing systems, 33:6840-6851, 2020. 8
[10] Ehsan Homaei, Khalil Farhangdoost, Edmond Ho Nang Pow, Jukka Pekka Matinlinna, Majid Akbari, and James Kit-Hon Tsoi. Fatigue resistance of monolithic cad/cam ceramic crowns on human premolars. Ceramics International, 42 (14):15709-15717, 2016. 1
[11] Jyh-Jing Hwang, Sergei Azernikov, Alexei A Efros, and Stella X Yu. Learning beyond human expertise with generative models for dental restorations. arXiv preprint arXiv:1804.00064, 2018. 1, 2
[12] Phillip Isola, Jun-Yan Zhu, Tinghui Zhou, and Alexei A Efros. Image-to-image translation with conditional adversarial networks. In Proceedings of the IEEE conference on computer vision and pattern recognition, pages 1125-1134, 2017. 2
[13] Thouis R Jones, Fredo Durand, and Mathieu Desbrun. Non-iterative, feature-preserving mesh smoothing. In ACM SIG-GRAPH 2003 Papers, pages 943-949. 2003. 2, 7
[14] STAVROS KILIARIDIS, MIHAIL G TZAKIS, and GUN-NAR E CARLSSON. Short-term and long-term effects of chewing training on occlusal perception of thickness. European Journal of Oral Sciences, 98(2): 159-166, 1990. 1
[15] STURE LUNDQVIST and TORGNY HARALDSON. Occlusal perception of thickness in patients with bridges on osseointegrated oral implants. European Journal of Oral Sci-546 ences, 92(1):88-92, 1984. 1
[16] David Marr and Ellen Hildreth. Theory of edge detection. 548 Proceedings of the Royal Society of London. Series B. Bio-549 logical Sciences, 207(1167):187-217, 1980. 3
[17] Xianfang Sun, Paul L Rosin, Ralph Martin, and Frank Lang-551 bein. Fast and effective feature-preserving mesh denoising. IEEE transactions on visualization and computer graphics, 13(5):925-938, 2007. 2
[18] Sukun Tian, Miaohui Wang, Ning Dai, Haifeng Ma, Linlin Li, Luca Fiorenza, Yuchun Sun, and Yangmin Li. Dcprgan: dental crown prosthesis restoration using two-stage generative adversarial networks. IEEE Journal of Biomedical and Health Informatics, 26(1):151-160, 2021. 1, 2, 7
[19] Bruno Vallet and Bruno Le′vy. Spectral geometry processing with manifold harmonics. In Computer Graphics Forum, pages 251-260. Wiley Online Library, 2008. 2
[20] Jun Wang, Jin Huang, Fu Lee Wang, Mingqiang Wei, Haoran Xie, and Jing Qin. Data-driven geometry-recovering mesh denoising. Computer-Aided Design, 114:133-142, 2019. 2 565
[21] LorenSen We. Marching cubes: A high resolution 3d surface construction algorithm. Comput Graph, 21:163-169, 1987. 1
[22] Wangyu Zhang, Bailin Deng, Juyong Zhang, Sofien Bouaziz, and Ligang Liu. Guided mesh normal filtering. In Computer Graphics Forum, pages 23-34. Wiley Online Library, 2015. 2
[23] Youyi Zheng, Hongbo Fu, Oscar Kin-Chung Au, and Chiew-Lan Tai. Bilateral normal filtering for mesh denoising. IEEE transactions on visualization and computer graphics, 17:1521-1530, 2010. 2

While the invention is explained in relation to certain embodiments, it is to be understood that various modifications thereof will become apparent to those skilled in the art upon reading the specification. Therefore, it is to be understood that the invention disclosed herein is intended to cover such modifications.

1. A computer-implemented geometric processing method for generating the design of a model of a dental prosthesis, comprising the steps of:
obtaining a blended prosthesis dataset for dental prostheses including natural tooth data and prosthesis tooth data designed by a technician;
preprocessing the data of the blended prosthesis dataset by generating a depth map so that the data is more suitable for deep learning (DL) in order to ensure generation of a smooth surface in a DL approach;
providing an artificial intelligence neural network generation model;
training the artificial intelligence neural network generation model on the preprocessed data; and
using the artificial intelligence neural network generation model to form a model of the prosthesis.

2. The computer-implemented geometric processing method according to claim 1 wherein preprocessing the data of the dataset is adapted to ensure generation of a smooth surface in a DL approach, the preprocessing step is a digital image/geometric pre-processing method using a filter with edge-preservation and a noise-reducing smoothing function.

3. The computer-implemented geometric processing method according to claim 2 wherein the digital image/geometric pre-processing method is one of a Bilateral filter for the image, a Bilateral Mesh Denoising function and/or a Bilateral Normal Filter for the mesh.

4. The computer-implemented geometric processing method according to claim 1 wherein the artificial intelligence neural network generation model is a combination of Residual Network (ResNet) and Generative Adversarial Network with Gradient Penalty (GAN-GP).

5. The computer-implemented geometric processing method according to claim 1 further comprising the step of applying a loss function to the artificial intelligence neural network generation model.

6. The computer-implemented geometric processing method according to claim 5 wherein
for the loss function of the artificial intelligence neural network generating model a special loss for the dental prosthesis is adapted for the occlusal and shape information by a fixed resolution or deep implicit representation (DIR) that learns a function which, given a coarse shape encoded as a vector, and the x-y-z/x-y coordinates of a query point, decide whether the query point is inside or outside of the shape, wherein the learned implicit function can be evaluated at query 3D/2D points at arbitrary resolutions, and the mesh/image can be extracted by applying classical marching cubes or other algorithms; and
wherein this output representation enables shape recovery at arbitrary resolutions, is continuous and can handle different topologies.

7. The computer-implemented geometric processing method according to claim 6 wherein special loss with tooth feature value for the dental prosthesis is used in conjunction with Regression loss function: Mean Absolute Error (MAE) loss (L1 loss), Mean Square Error (MSE) loss (L2 loss), smooth L1 loss, Huber loss, perceptual loss; or with the loss function in GAN including Jensen-Shannon (JS) Divergence loss and Wasserstein loss.

8. The computer-implemented geometric processing method according to claim 1 further comprising the steps of:
identifying the dental information associated with the dental model of dentition;
generating a 3D dental prosthesis surface with a post-processing method to meet the requirement of the dental prosthesis; and
completing the rest of the dental prosthesis to meet full function.

9. The computer-implemented geometric processing method according to claim 1 wherein the blended prosthesis dataset further includes tooth data designed by a technician with clinical adjustment of the occlusion so as to integrate natural tooth, technical design tooth and clinically adjusted tooth data.

10. The computer-implemented geometric processing method according to claim 1 wherein the artificial intelligence neural network generation model is a deep learning DL model with fixed resolution or deep implicit representation (DIR) which generates the dental prosthesis with macro shape and micro pit and fissure.

11. The computer-implemented geometric processing method according to claim 1 wherein Delaunay triangulations are used to build 3D topological structures from unorganized (or unstructured) points during generation of the dental prosthesis model.

12. The computer-implemented geometric processing method according to claim 8 wherein Adjusted Non-Iterative, Feature Preserving Mesh Filtering is used to smooth the generated dental prosthesis model in which each pixel in the depth map has the same area on the projection plane.

13. The computer-implemented geometric processing method according to claim 1 wherein adjacent teeth constraints are used in the generated dental prosthesis model to achieve alignment.

14. The computer-implemented geometric processing method according to claim 8 that combines modified DT reconstruction to achieve accurate and mechanically suitable results at a 256×256 depth map resolution for 3 units of teeth.

15. The computer-implemented geometric processing method according to claim 8 wherein a generated outer surface of the generated dental prosthesis model is registered at the corresponding position in 3D space with sufficient accuracy for clinical applications by offsetting an upper part of the tooth abutment outer surface by a given distance to simulate the use of an adhesive layer and designing a connector mesh surface by using the boundary curves of the generated outer surface (i.e. the occlusal surface and the adhesive layer) as the reference lines.

16. The computer-implemented geometric processing method according to claim 14 wherein a 3D reconstruction is generated by the marching cubes (MC) method wherein the depth map is converted into a voxel representation followed by the MC method, which constructs a faceted iso-surface by processing the data set in a sequential, cube-by-cube manner.
